(19) United States
(12) Patent Application Publication
(10) Pub. No.: US 2007/0034020 A1
(43) Pub. Date: Feb. 15, 2007

(54) Spiral Bubble Rotation Indicator

(75) Inventors: Tommy Tulloch, Fife, Scotland (GB); Steve Buchan, Perth, Scotland (GB); Richard Dempster, Fife, Scotland (GB); Ralph Brooker, Alexandria, VA (US)

Correspondence Address: BABCOCK IP, PLLC, P.O.BOX 488, 4934 WILDWOOD DRIVE, BRIDGMAN, MI, 49106, US

(73) Assignee: ANDREW CORPORATION, Orland Park, IL (US)

(21) Appl. No.: 11/161,635

(22) Filed: Aug. 10, 2005

(51) Int. Cl. G01L 3/00

(52) U.S. Cl. 73/862.08

(57) ABSTRACT

A rotation indicator assembly having an inner sleeve with an outer surface surrounded by an outer sleeve. The outer sleeve seals a spiral pathway between the inner and outer sleeves. The spiral pathway is filled with at least a first material and a second material of different densities, for example a liquid and a gas.

### BACKGROUND OF THE INVENTION

The present invention relates to rotation indication, and more specifically to a durable and cost effective rotation indicator for indicating a portion of a single rotation and or multiple rotations with precision.

High resolution rotation adjustments to rotatable elements such as nuts, bolts or gear shafts, for example during antenna orientation fine tuning, consume a significant portion of time required during installation and or performance optimization. During final fine adjustment, only a portion of a rotation and or a specific number of rotations may be desired. Where adjustments are made, for example, in a narrowing range scheme it is desirable to have a clear indication of the magnitude of the previous adjustment to be able to exactly repeat a desired fraction or multiple of the previous adjustment, in either direction.

Rotation of a single turn is easily represented by graduated indicia formed 360 degrees around the target rotatable element. Typically these adjustments are made with respect to precision graduated indicia formed integral with the apparatus to be adjusted. The required indicia and associated indication structure(s) increases the complexity and costs of the apparatus.

Graduated indicia on apparatus intended for environmental exposure over extended periods must be durable, often requiring the formation of the graduated indicia via the additional expense of metal stamping or engraving operations rather than merely painting or applying a printed sticker. Also, these indicia have a fixed reference or zero point, requiring further user calculations, the addition of a separate indication element and or attaching the tool used for adjustment always at a known orientation. These procedures may be difficult because the position of the rotatable element before further adjustment depends upon the last adjustment made.

Bubble rings, pendulum devices and the like have been used as rotation indicators and in levels to indicate rotation angle with respect to a reference plane. However, multiple rotations require the user to mentally or otherwise manually record the rotation progress. A prior conical spiral rotation indicator used a mechanical linkage to move an indicator element along a spiral, as the spiral was rotated, to hide more or less of the indication element only when viewed from a front viewing position, thus representing the cumulative rotation of the shaft the indicator was mounted upon. Because of the mechanical linkage to the shaft, the rotation indication cannot be easily reset once rotation has been initiated. A mechanical linkage of this type is also susceptible to damage from mechanical vibration and is relatively delicate and expensive to manufacture, limiting its practical application to complex permanent installations where one rotation indicator is supplied integral with each desired rotatable element.

Competition within industry has focused attention upon ease of use, accuracy and reliability. Factors of commercial success also include reduction of manufacturing, materials and assembly costs.

Therefore, it is an object of the invention to provide a rotation indicator that overcomes deficiencies in such prior art.

### BRIEF DESCRIPTION OF THE DRAWINGS

The accompanying drawings, which are incorporated in and constitute a part of this specification, illustrate embodiments of the invention and, together with a general description of the invention given above, and the detailed description of the embodiments given below, serve to explain the principles of the invention.

FIG. 1 is an isometric schematic angled side exterior view, of the inner sleeve of a first embodiment of the invention.

FIG. 2 is an isometric schematic angled side cross section view, of the first embodiment of the invention.

FIG. 3 is an isometric schematic angled side view of the first embodiment.

FIG. 4 is a schematic angled view of a second embodiment of the invention.

FIG. 5 is a schematic front view of the second embodiment of the invention.

### DETAILED DESCRIPTION

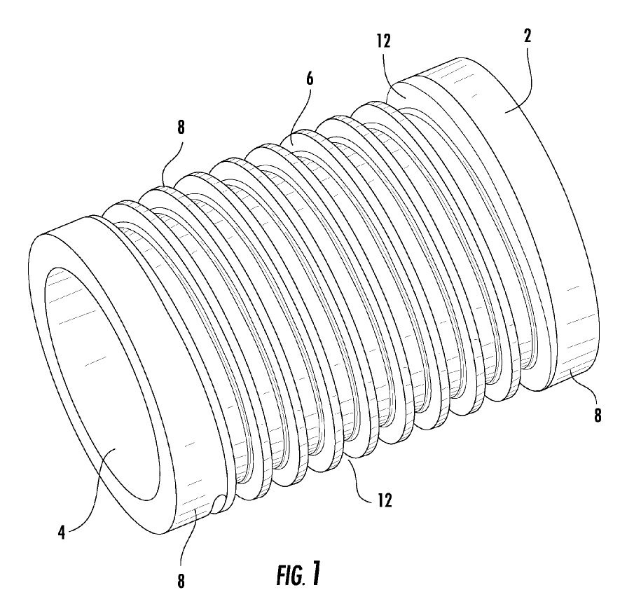

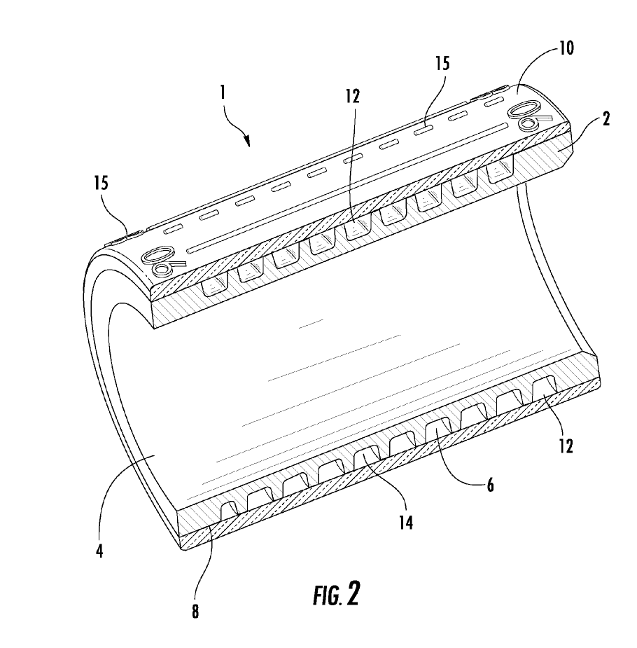

As shown in FIGS. 1-3, an exemplary first embodiment of a spiral bubble rotation indicator assembly 1 according to the invention may be formed as a cylindrical package for mounting upon and or integration with a desired tool, shaft or other assembly. As best shown in FIGS. 1 and 2, an inner sleeve 2 has a mounting bore 4 corresponding to a desired mounting surface and a spiral channel 6 formed about the outer surface 8. An outer sleeve 10 is dimensioned to fit over the inner sleeve 2 outer surface 8, closing an open end 12 of the spiral channel 6 to form an enclosed spiral pathway 14. While the invention is demonstrated herein with the spiral channel 6 formed in the outer surface 8 of the inner sleeve 2, one skilled in the art will recognize that the spiral channel 6 may alternatively be formed upon an inner surface of the outer sleeve 10.

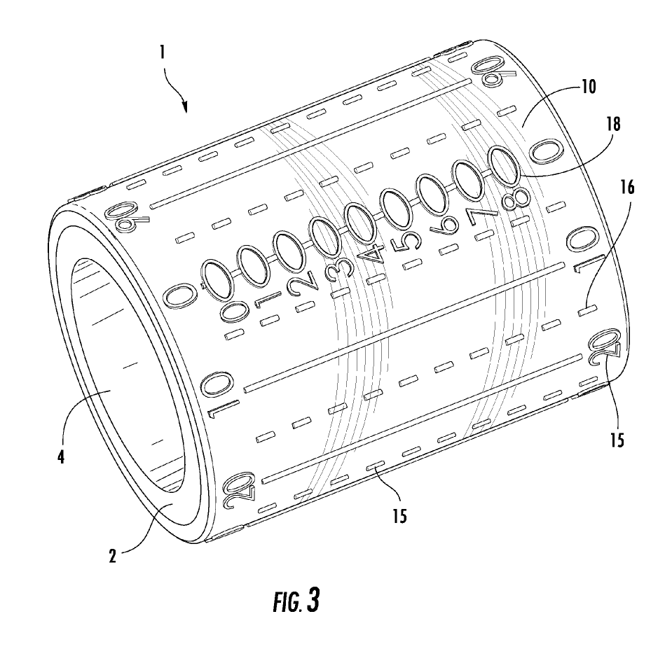

The outer sleeve 10 is preferably formed from a translucent material such as polycarbonate, ABS, acrylic or other plastic material, with a range of graduated indicia 15 having circumferential increment(s) 16 extending circumferentially around the outer sleeve and also longitudinal increment(s) 18 along the longitudinal dimension, respectively, for example as shown in FIG. 3. Both the inner and outer sleeves 2, 10 may be cost effectively manufactured via injection molding.

The enclosed spiral pathway 14 is sealed from the exterior of the assembly 1, for example, by an interference fit and or application of an adhesive/sealant to create a liquid tight seal. A first and a second material 20, 22 introduced into the spiral channel 6, for example a liquid and a gas bubble, respectively, before it is sealed may thereby be permanently encapsulated. By force of gravity the first or second material having a lower density, in this example the gas bubble, will rise towards the top of the assembly 1, moving along the spiral pathway 14 as the assembly 1 is rotated, providing a visual indication of the assembly 1 rotation via the gas bubble displacement along the spiral pathway 14.

The number of turns the spiral channel 6 extends around the inner sleeve 2 is also the number of sequential rotations the assembly 1 may indicate without requiring manual rotation of the assembly 1 about the rotation target to reset the position of the, for example, gas bubble. An upper limit of the number of spiral channel 6 turns is reached when the resulting assembly 1 becomes unacceptably long in the longitudinal dimension.

The graduated indicia 15 may be molded or engraved integral with the outer sleeve 10 or applied via painting or the like. In the present embodiment, the circumferential increment 16 of the graduated indicia 15 divides a single rotation of the assembly into 100 circumferential increment(s) 16. The longitudinal increment 18 of the graduated indicia 15 is directly related to the number of turns available, here eight turns. The longitudinal increment 18 may be sequential, as shown, or rise and fall towards either end from a central zero indication.

The enclosed first and second materials 20, 22 should be immiscible and of significantly different densities. Further material selection criteria may include long term stability, resistance to freezing and acceptable expansion and contraction in response to expected temperature variation exposure for the assembly 1. For ease of viewing the position of the, for example, gas bubble through the outer sleeve 10 in low light conditions the, for example, liquid may be selected from a range of available luminous liquids as commonly applied to conventional carpenters bubble level capsules.

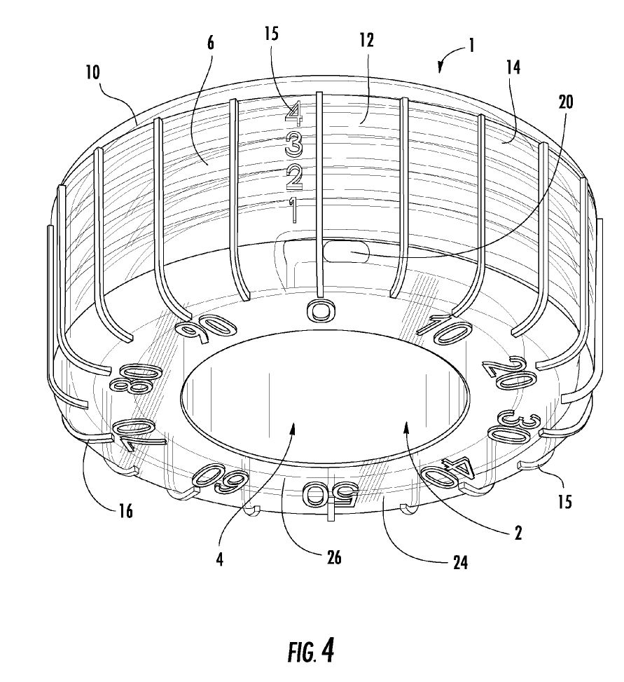

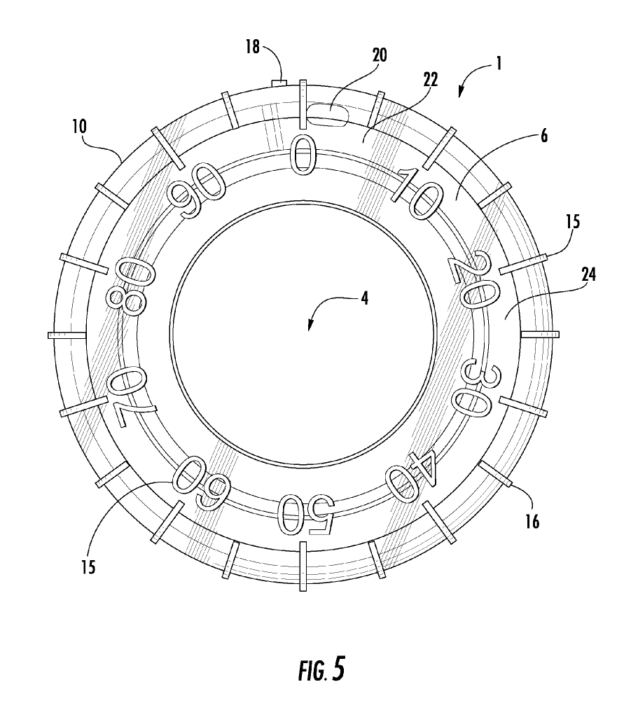

As described herein above, the rotation indication provided by the assembly 1 is viewed from above with respect to the direction of gravity. Alternatively and or additionally, the spiral channel 6 may be filled with a portion of a third material that has a higher density than the first and second materials 20, 22, such as mercury, a metal ball bearing or the like which then provides an equivalent rotation indication from a bottom view perspective. A front view rotation indication of a portion of a first rotation may be added to the assembly 1 by forming the spiral channel 6 with an open side 24 at an end 26 of the inner sleeve 2 and adapting the outer sleeve 10 to cover and seal also against that end 26, for example as shown in FIGS. 4 and 5.

Installed upon and or integrated with desired equipment, the assembly 1 is preferably manually rotatable about the mounting surface, allowing the assembly 1 to be zeroed as desired before rotation is initiated. One skilled in the art will recognize that the assembly may be readily mounted upon and or incorporated with apparatus adjustment shafts, hand tools and tool attachments such as ratchet wrench extensions or the like. Further, while the invention has been demonstrated in cylindrical embodiment(s), other shapes having, for example, rectangular, triangular or oval cross sections may also be applied. In these embodiments, the shapes themselves may operate as indicia for the operators quick reference.

The invention provides a rotation indication assembly that is cost effective to manufacture, rugged, reliable and precise.

Table of Parts

| | |
|---|---|
| 1 | assembly |
| 2 | inner sleeve |
| 4 | mounting bore |
| 6 | spiral channel |
| 8 | outer surface |
| 10 | outer sleeve |
| 12 | open end |
| 14 | spiral pathway |
| 15 | graduated indicia |
| 16 | circumferential increment |
| 18 | longitudinal increment |
| 20 | first material |
| 22 | second material |
| 24 | open side |
| 26 | end |

Where in the foregoing description reference has been made to ratios, integers or components having known equivalents then such equivalents are herein incorporated as if individually set forth.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus, methods, and illustrative examples shown and described. Accordingly, departures may be made from such details without departure from the spirit or scope of applicant's general inventive concept. Further, it is to be appreciated that improvements and/or modifications may be made thereto without departing from the scope or spirit of the present invention as defined by the following claims.

What is claimed is:

1. A rotation indicator, comprising:
an inner sleeve having an outer surface surrounded by an outer sleeve;
the outer sleeve covering an open end of a spiral channel around the outer surface, forming a spiral pathway;
the spiral pathway filled with a first material and a second material;
the first material and the second material having different densities.

2. The rotation indicator of claim 1, wherein the inner sleeve has a mounting bore along a longitudinal axis.

3. The rotation indicator of claim 1, wherein the outer sleeve has graduated indicia.

4. The rotation indicator of claim 3, wherein the graduated indicia has circumferential and longitudinal increments.

5. The rotation indicator of claim 3, wherein the graduated indicia is integral with the outer sleeve.

6. The rotation indicator of claim 1, wherein the outer sleeve is translucent.

7. The rotation indicator of claim 1, wherein the spiral pathway has more than one turn around the inner sleeve.

8. The rotation indicator of claim 1, wherein the first material is a liquid and the second material is a gas.

9. The rotation indicator of claim 8, wherein the first material is luminous.

10. The rotation indicator of claim 1, wherein the first material and the second material are immiscible.

11. The rotation indicator of claim 1, further including a third material in the spiral pathway.

12. The rotation indicator of claim 11, wherein the third material has a higher density than the first material and the second material.

13. The rotation indicator of claim 11, wherein the third material is one of mercury and a metal ball.

14. The rotation indicator of claim 1, wherein the spiral channel is formed extending to an end of the inner sleeve with an open side at the end; and the outer sleeve is formed to seal also against the end.

15. A rotation indicator, comprising:
an inner sleeve having a mounting bore along a longitudinal axis and an outer surface surrounded by a translucent outer sleeve;
the outer sleeve covering an open end of a spiral channel around the outer surface, forming a spiral pathway having more than one turn around the inner sleeve;
the outer sleeve having integral graduated indicia with circumferential and longitudinal increments;
the spiral pathway filled with a luminous liquid and a gas.

16. A rotation indicator, comprising:
an inner sleeve;
an outer sleeve;
the inner sleeve dimensioned to fit within the outer sleeve, sealing a spiral pathway between the inner sleeve and the outer sleeve;
the spiral pathway filled with at least a first material and a second material;
the first material and the second material having different densities.

17. The rotation indicator of claim 16, further including graduated indicia visible from an exterior of the rotation indicator.

18. The rotation indicator of claim 17, wherein the graduated indicia include both longitudinal and circumferential graduations.

19. The rotation indicator of claim 16, wherein the first material is a liquid and the second material is a gas.

20. The rotation indicator of claim 16, wherein the spiral pathway has more than one turn.
